(19) United States
(12) Patent Application Publication
(10) Pub. No.: US 2010/0257060 A1
(43) Pub. Date: Oct. 7, 2010

(54) DIGITAL SIGNAGE AUCTION METHOD AND SYSTEM

(76) Inventor: William M. Kountis, Raleigh, NC (US)

Correspondence Address: PASSE' INTELLECTUAL PROPERTY, LLC, 1717 BRASSFIELD RD., RALEIGH, NC, 27614, US

(21) Appl. No.: 12/419,135

(22) Filed: Apr. 6, 2009

(51) Int. Cl. G06Q 30/00

(52) U.S. Cl. 705/14.71; 705/27; 705/30; 705/26

(57) ABSTRACT

The present invention relates to an auction system which operates over a digital communications system. The system allows for the provider of digital signage space to offer advertising space on digital signs, such as billboards and the like, located at retail or special event locations. To buyers of digital advertising space in such a way that an orderly market for such advertising space is created and that a buyer can search for the particular advertising space based on price location, demographics and the like to target the advertising purchases in this media.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a method and system for providing a market for digital signage advertising. In particular the present invention relates to a method of bringing together digital signage airtime providers with media buyers and advertisers in an internet based auction system.

2. Description of Related Art

Digital signage, also called dynamic signage, is a specialized form of slivercasting in which video or multimedia content is displayed in public places for informational or advertising purposes. A digital sign usually consists of a computer or playback device connected to a large, bright digital screen such as an LCD or plasma display.

Digital signage is used in department stores, schools, libraries, office buildings, medical facilities, airports, train and bus stations, banks, auto dealerships and other public venues. If the display is connected to a computer, the data on the screen can be updated in real time by means of an Internet or proprietary network connection. Data transmission and storage are streamlined by compression to minimize file size. The system can employ multiple screens if an extra-large display is desired and can be transmitted to multiple locations.

There are several advantages to the use of digital signs instead of paper signs. Digital signs can be updated at will by remote control while paper signs require individual replacement and physical travel to sign sites by personnel. Because digital signs require no paper or paint, they are more environmentally friendly than traditional signs. Digital signs can be animated and can deliver sound as well as visual content. In many digital signs the particular screen shot that a viewer views is broken up into quadrants such that multiple active or static advertisements can appear on the screen at the same time. The provider of the digital sign then can provide multiple advertisements at the same time.

One way that digital signage makes money is to sell advertising on the particular system. That requires the owner of the digital signage system to employ individuals who must find ways of obtaining advertisers for their particular system. This is a costly method of obtaining advertising and frequently the cost of obtaining advertisers exceeds the financial benefit obtained. Each digital signage system, of which there are hundreds if not thousands, is faced with the same difficulty. Likewise, advertisers do not have an easy task finding these targeted digital signs to advertise with.

In order to enhance the availability of digital signage and provide a means of advertisers finding available signage, a new means would be useful.

### BRIEF SUMMARY OF THE INVENTION

The present invention relates to a method and system for matching and creating a market for digital signage advertising. The present invention relates to associating one or more advertisers with one or more digital advertising offerings for the purpose of creating an auction and price for this area of advertising. The present invention overcomes the problems, and the like, associated with digital advertising that have not been addressed before.

In one embodiment of the present invention, there is a method for providing an auction for digital signage advertising comprising:
a) maintaining a database of available digital signage advertisements from one or more digital signage advertisement providers on a server connected to a communications network;
b) providing a communications network interface for digital signage advertisement advertisers for viewing the available advertisements on the server;
c) providing a bidding auction process over the communications network for one or more advertisers to bid on one or more advertisements; and
d) selecting the winning auction bid after a selected period of time.

In yet another embodiment, there is a system for providing a communications network based auction for digital signage advertising comprising:
a) a database system that that collects available digital signage advertising details for presentation to the communications network;
b) a presentation module on a server for presenting a communication network interface with the advertising details; and
c) a bid module on a server that allows one or more advertising purchasers interfacing with the presentation module on the communications network to place a bid on the advertising, the module selecting a winning bid from the placed bids.

In yet another embodiment, there is a method of creating a market in digital signage advertising comprising:
a) collecting data from digital signage content providers about available digital signage advertising space;
b) storing the data about advertising space on a database;
c) presenting the stored data to a communications network in a desired format;
d) providing a means for potential digital advertising buyers to view the stored data on the communications network; and
e) providing a system over the communications network for buyers to bid on the advertising space until a winning bid is determined.

In yet one more embodiment, there is disclosed a process for selling digital signage advertising to one or more digital signage advertisers comprising:
a) linking a digital signage advertising provider to a database provider over a communications network to obtain advertising data; and
b) linking the database holder to the one or more digital signage advertisers over a communication network in a bidding relationship to associate the advertising with the buyer.

### BRIEF DESCRIPTION OF THE DRAWINGS

FIG. 1 is a relationship figure of the present invention.

FIG. 2 is a relationship diagram of the action modules of the present invention.

FIG. 3 is a flow chart of an embodiment of the present invention.

FIG. 4 is a block diagram of an embodiment of the invention relating to the positioning of a database.

FIG. 5 is a flow chart of an embodiment of the invention.

FIG. 6 is a block diagram of an embodiment of the present invention.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

The term “digital signage advertising” refers to advertising that appears on digital screens at venues usually in the form of a static screen advertisement rather than a video, however, multiple formats are intended within the scope of the invention. In one embodiment of the present invention, digital signage advertising refers to signs which display portions of the screen with different advertisements. Typically a screen is divided into 4 or more quadrants which each can hold a static advertisement or video. These types of displays can be electronic billboards at retail vendors, any place where the public is, indoor and outdoor venues and the like or at special events, such as at stadiums and convention centers where concerts, trade shows and the like appear and digital signage is frequently used or places which also might wish to list their signage timeslots next to their list of events or the like.

As used herein, the term “database” refers to a computer or other digital storage media or device for storing data in an organized digital manner. A customized database would be used and could be stored on the server computer that feeds information and data to a communications network or on a separate computer with a connection for delivering the data to the server computer, other data bases or to a module which processes the data and determines winning bids. The advertisement database will store data about digital signage advertisements such as time, location, digital signage advertising provider, minimum acceptable price, length of advertisement, type of location and any other data necessary to understand the particular advertisement and place on a communications network Graphic User Interface (GUI) for use by a person seeking advertising. The Bid Information Database will store information about bids made on particular advertisements, the bidder, bid ranges, keep track of multiple bids and the like. The database system of the two data bases, either on one or more computers or one or more database software, will keep tract of the two pieces of data coming from the seller and buyer of the entire present invention. Data is delivered to each of the databases via interfaces in the communications network which deliver usable information and receive information from users to be entered into the databases.

The database can also carry information regarding the demographics of the particular advertising space to the provider. Therefore information relating to age, sex, and income level of the normal viewers of the information can be provided. Additional information such as impressions, location, industry sector and price point could also be included. By including the additional classifications of information one searching for the particular advertising space can more clearly tailor their needs to the available advertising space. The demographic information could be provided by any of the parties involved or in some instances and embodiments the demographic information could be supplied by a third party to the present invention but included in parameters available for searching by including the information on one or more of the databases to the system.

The system can also allocate that a particular purchaser may have a budget to work within, then purchases on the auction system would only allow the individual to commit to advertising within a given budget. This is a useful feature where multiple advertising needs to be purchased.

Another embodiment of the present invention allows the ad buyer to purchase a portion of a screen wherein the screen is zoned. For example, an ad buyer bids on ¼ of a screen at a particular time slot. Where portions of screens are available for purchase of part of a zoned screen, advertising is maximized by increasing the number of advertising screens one can buy advertising on. While a zone advertisement could potentially cost more per square inch than a full screen ad, the availability of an increase number of views for some advertisers may more than make up for that cost.

As used herein, a “communications network” refers to the Internet, an intranet, or any large scale computer based interactive communication system networked through a computer system. While the Internet will be referred to herein, other types of communications systems, whether currently used or not, are intended. The user of the present invention will determine which available communications network will work best for their particular needs.

As used herein, a “communications network interface” refers to a means for viewing and interacting with the information and to participate in the bid process over the communications network. A GUI presenting available advertisements at an Internet web site, for example, could be used. There could be an advertising GUI as well as an advertiser/bidder GUI. Each interface allows the user to obtain information as well as leave their portion of the bid information on the system of the present invention.

As used herein, the “bidding auction process” refers to software or other means residing on a computer such as a server and connected to the CN interface such that the bidder/advertiser can see the available advertisements, view their characteristics, and place a bid on the particular advertisement. The process collects the bids from the bidders, compares them, matches them and after a period of time selected by the user of the present invention, selects a high bidder awarding the advertising space at the given bid price. The “winning auction bid” is selected based on any convenient parameters but in general highest price at the end of a selected period of time is the most common in auctions and represents an embodiment of the present invention.

A “presentation module,” as used herein, refers to the computer software internet connection means and the like that takes data from the data base regarding the advertising offered and is capable of presenting it over the internet. As described above, by using an interface or the like which can all be present on a given server for linking to the internet, the appropriate data for bidding upon can be presented to a bidder on the internet.

A “bid module,” as used herein, is the processing and interface for the bidder. The bid module allows the advertising purchasers, such as the bidders, to interface with the presentation module by taking the bid or bids placed on the advertising coordinating with the presentation module and selecting a winning bid from all the bids received by the bid module for an advertisement on the presentation module.

As further described and claimed herein, the digital signage advertising provider is linked to the database provider. The database provider is the entity which controls the bid process and controls the advertising providers as well as the bidder/purchasers. The advertising provider and database provider are linked in such a way that the advertising provider can interact over the internet and provide details of the advertising slots to the database provider's database over the internet. Likewise, the database provider is linked to one or more advertisers/bidders in a bidding relationship in such a way that the highest bid becomes associated with the particular advertising space offered at auction.

In specific embodiments of the present invention system, there can be other included elements for the auction system. Since the present invention system allows for both the ad vendor and ad buyer to perform their respective operations over a communications network it is possible to set up direct notification systems. For example, a particular advertisement vendor could notify those buyers signed up or on the system with notifications of available or upcoming inventory, specials, new opportunities and the like. Likewise buyers could post particular needs to the site or to vendors for the purpose of suggesting new or existing advertising parameters they might be interesting in bidding on.

The present system could also be used by either the buyer or vendor to create and/or manage their particular campaign. By including additional software for record keeping, demographics, budgets and the like, the entire purchasing process can be tracked by any party to the present invention. Likewise, since money needs to be exchanged in the purchase of the advertising space the present invention system could also include an integrated pay system. This would allow tracking and creation of invoices, balances and even payments, for example, by credit card or other online payment services such as PayPal and the like.

One embodiment of the present invention would allow the buyer to view on a digital map the exact location of the digital sign. For example, the site could be tied to Google maps, MSN maps or the like to produce a sign location. The vendors, likewise, could upload actual photos of the screen in its location during use. That way a potential buyer could see the screen and judge the applicability of the location by viewing the location.

In another embodiment of the present invention, the auction system of the present invention can be paired with third party vendors of products for the digital signage trade. For example, in one embodiment the present invention is paired with an audience measurement product such as currently provided by Cognovision. Other products which exist or are developed could also be used in conjunction with the present auction system.

Further explanation comes from the specific embodiments outlined in the figure descriptions and claims which follow. The flow diagrams and other charts show an order for simplicity and do not represent the only order that elements could occur. One skilled in the art in view of the disclosure herein could re-order the elements as needed to achieve embodiments within the scope of the present invention.

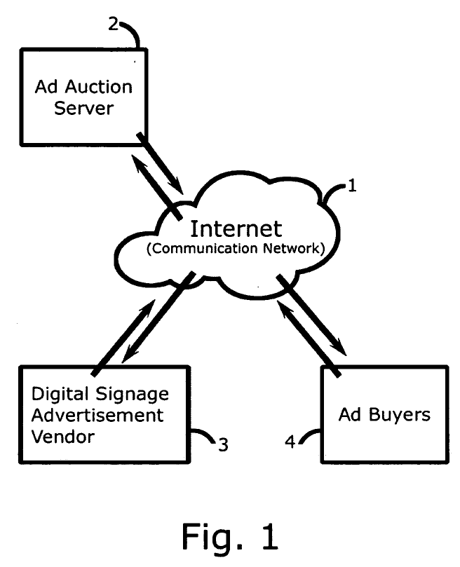

Now referring to the drawings, FIG. 1 is an embodiment of the present invention showing the relationship of elements of the present invention to a communications network 1. The provider of an auction establishes an ad auction server 2 to collect advertising and bids and to match them and pick a winning bid. The server 2 is connected in an interfacing method to the internet 1. The server 2 can be a single computer or multiple computers which work together to provide the auction process and connect to the internet. The figures, as an example, assume a single server/computer but one skilled in the art could easily chose as many computer server connections as necessary to practice a desired embodiment of the invention. The digital signage advertisement vendor 3 is also connected to the internet 1 in an interfacing method to download advertisement space to the server 2. The ad buyer 4, who can become the bidder if he sees an appropriate ad to place a bid on, is also connected to the internet 1 in an interfacing method. The result of this connection is the server 2, the vendor 3 and buyer 4 are all linked by their connection to the internet 1.

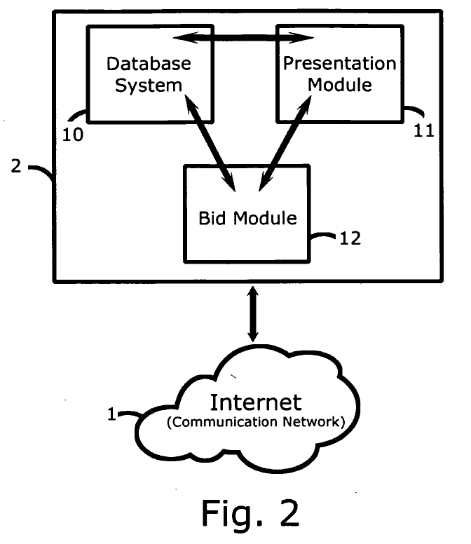

FIG. 2 shows an embodiment of the present invention showing the elements of the server 2 connected to internet 1. In this embodiment the server 2 consists of a database system 10. The database system 10 comprises as taught above the means for storing data about the digital signage advertisement vendor's advertisements that are offered for sale, the bid information, details about the participants in the auction process, the winning bids and the like. The bid module 12 collects the information from an ad buyer(s) and processes them and selects the winning bid. Lastly, the presentation module 11 prepares the data from the database 10 for presentation to the internet 1 as well as present a GUI interface for collection information from the vendor and buyers of the system.

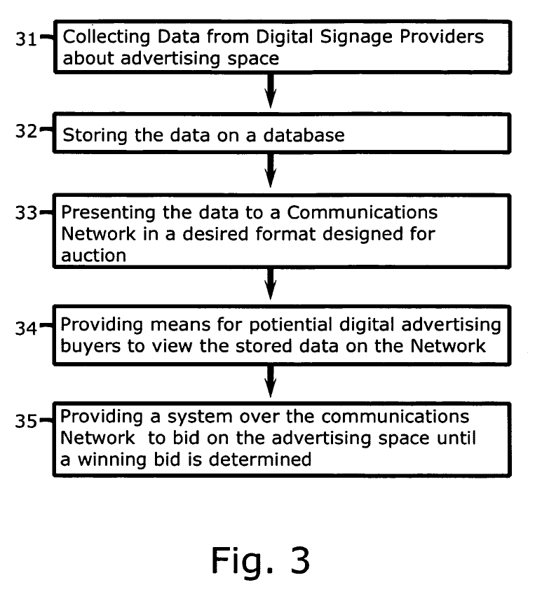

FIG. 3 is a flow diagram of an embodiment of the present invention. Initially a digital signage provider collects data about their available advertising space 31. The provider chooses, based on its own criteria of those ad spaces it wishes, to auction off or otherwise create a market for their advertising space. Once the provider accumulates one or more advertisements for auction the data is uploaded to a database 32. The database is provided by the auction service so that the storing occurs but uploading over the internet and delivering to a database, for example, are accomplished on the auction server.

The server organizes the data on the database from all advertising providers and presents the data to the internet in a desired format (e.g. a GUI) designed to establish an auction 33. The auction format interface is simply a listing of available advertising spaces, starting prices (if any) and an interface for bidders/buyers to use to bid on the advertising space.

The server also presents, as noted above, a GUI or other presentation format for digital advertising buyers/advertisers to view the advertising data stored on the database 34. The same GUI, web site or other interface format can be used to deal with the buyer. Collecting details about the buyer, allowing the buyer to register, taking purchasing information like credit cards or methods of payments and the like, can all be entered at this point.

Lastly in this embodiment, the system provides a bid module or other bidding means to allow the bidder to place a bid on the available advertisement, collect the bids and determine a winning bid after a selected period of time 35. A variety of bid/auction parameters can be used, but one skilled in the art could choose selected parameters based on need and the system set up to create the market.

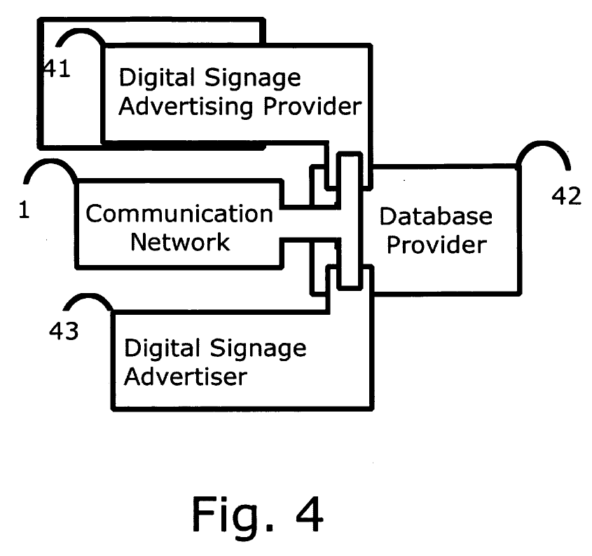

Now looking at FIG. 4, there is presented a block diagram of an embodiment of the present invention. This particular graphic representation notes the linking relationships the different parties to the present invention can have. The digital signage provider 41, database provider 42 and digital signage advertiser 43 are all in a linkage relationship connected by the link created by connecting to the internet 1. The linked relationship allows the information of an auction system to produce a market for the provision of digital signage advertising within the scope of the present invention.

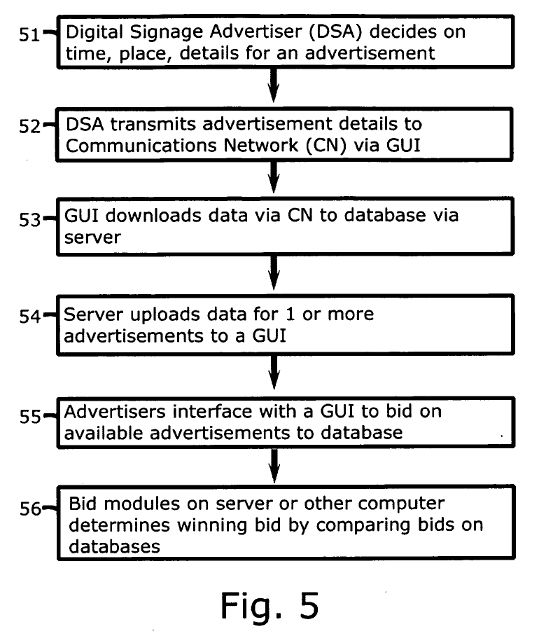

FIG. 5 represents yet another embodiment of the present invention. The digital signage advertiser begins by deciding on details for an advertisement, such as the time it runs on which screens, the length, the number of times, and the like, for one or more advertisements 51. The parameters of each advertisement will be up to the individual DSA based on their own parameters and on any restrictions initiated by the auction provider of the present invention. However, the exact details once the process is established will be within the skill of the art to determine. Next, the DSA goes on the internet to the auction web site, finds the DSA interface, enters it and transmits/enters the advertisement details 52.

Once the DSA has entered the information on the GUI, the internet system which is connected to an Auction server transmits or otherwise downloads data to a database on the server 53. As described above this can be one or more servers and can be accomplished a number of ways over the internet linkage. The Database can later provide the downloaded back up to a GUI (54) where advertiser interfaces with a different GUI to bid on the available advertisements from the database 55. Once the bids are collected the bid module on the server or other computer determines the winning bid by comparing bids also collected on a database 56. At the end the parties which are all linked can exchange the price of the advertisements and the money for the advertisements by any convenient means.

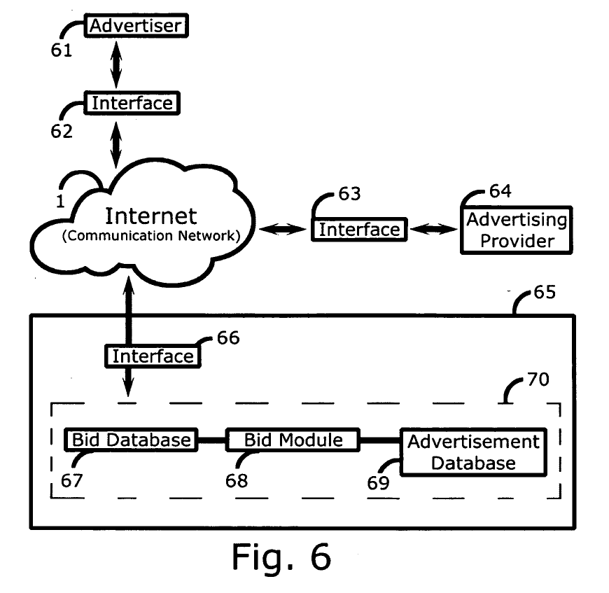

FIG. 6 depicts yet another embodiment of the present invention. Once again the internet 1 is shown with the elements of the system of the present invention. An advertiser 61 interacts with internet interface 62 in order to search out and eventually bid on advertising for digital signage. The advertising provider 64 also acts with an internet interface 63 which allows the provider 64 to upload their available advertising space over the internet 1 to a server 65. The server also has an internet interface 66 which allows the sever to provide service and a linkage to both the advertising provider 64 and the advertiser 61. The server 65 also has modules and databases for creating the market and auction process for digital signs shown as system 70. System 70 comprises a bid database 67 for collecting the bids from advertisers 61 and an advertisement database 69 for checking the available advertising space from the advertising provider 64. The bid DB 67 and advertisement DB 69 are linked in the system 70 to a bid module 68 which takes the two databases and chooses a winning bid matched to a particular available advertisement on a digital sign.

It is apparent that the present invention provides a method and system for auctioning and creating a market in Digital signage advertisements. The advantages and objects are particularly clear from the disclosure above. While the present invention has been described in conjunction with specific embodiments it is evident that there are many alternatives, modifications and variations which fall within the spirit and broad scope of the claims which follow. Nothing in the specific embodiments are intended to be read as otherwise limiting.

What is claimed is:

1. A method for providing an auction for digital signage advertising comprising:
a) maintaining a database of available digital signage advertisements from one or more digital signage advertisement providers on a server connected to a communications network;
b) providing a communications network interface for digital signage advertisement advertisers for viewing the available advertisements on the server;
c) providing a bidding auction process over the communications network for one or more advertisers to bid on one or more advertisements; and
d) selecting the winning auction bid after a selected period of time.

2. A method according to claim 1 wherein the database includes desired demographics of the viewers of the digital signage which can be used to search for a desired advertisement.

3. A method according to claim 1 wherein the database includes demographics on industry information about the advertising signage being offered which can be used to search for a desired advertisement.

4. A method according to claim 1 wherein the digital signage advertisement offers zoned screen advertisements.

5. A method according to claim 1 wherein the digital signage is at special event digital sign locations.

6. A method according to claim 1 wherein the digital signs are digital billboards.

7. A method according to claim 1 wherein the parties to the auction can communicate information to each other in addition to the auction information.

8. A method according to claim 7 wherein the advertisement vendor can contact the advertisement buyer with a list of available inventory.

9. A method according to claim 1 which further comprises an invoicing system to track advertisements and payments.

10. A method according to claim 1 which further comprises a system for budgeting the allowable funds that a buyer can spend at a digital auction.

11. A method according to claim 1 wherein third party audience measurement products are included in the method.

12. A method according to claim 1 wherein the digital signage is outdoor digital signage.

13. A method according to claim 1 wherein the method provides a digital online map to show the geographic location of a desired digital signage offered for auction.

14. A system for providing a communications network based auction for digital signage advertising comprising:
a) a database system that that collects available digital signage advertising details for presentation to the communications network;
b) a presentation module on a server for presenting a communication network interface with the advertising details; and
c) a bid module on a server that allows one or more advertising purchasers interfacing with the presentation module on the communications network to place a bid on the advertising, the module selecting a winning bid from the placed bids.

15. A system according to claim 14 which further comprises demographic data about available advertising which can be searched on the communications network.

16. A system according to claim 14 which allows for the auctioning of zoned screen advertising.

17. A system according to claim 14 which further comprises an invoicing system.

18. A system according to claim 14 which further comprises a third party audience measurement system.

19. A method of creating a market in digital signage advertising comprising:
a) collecting data from digital signage content providers about available digital signage advertising space;
b) storing the data about advertising space on a database;
c) presenting the stored data to a communications network in a desired format;
d) providing a means for potential digital advertising buyers to view the stored data on the communications network; and
e) providing a system over the communications network for buyers to bid on the advertising space until a winning bid is determined.

20. A process for selling digital signage advertising to one or more digital signage advertiser comprising:
a) linking a digital signage advertising provider to a database provider over a communications network to obtain advertising data; and
b) linking the database provider to the one or more digital signage advertiser over a communication network in a bidding relationship to associate the advertising with the buyer.
